(19) United States
(12) Patent Application Publication
(10) Pub. No.: US 2025/0129107 A1
(43) Pub. Date: Apr. 24, 2025

(54) HYDROSILYLATION PROCESS PHOTOCATALYSED BY A MANGANESE COMPLEX

(71) Applicants: Elkem Silicones France SAS, Lyon (FR); CENTRE NATIONAL DE LA RECHERCHE SCIENTIFIQUE, Paris (FR); UNIVERSITE CLAUDE BERNARD LYON 1, Villeurbanne (FR); CPE Lyon, Villeurbanne (FR)

(72) Inventors: Raphaël MIRGALET, Lyon (FR); Anthony VIVIEN, Villeurbanne (FR); Clément CAMP, Lyon (FR); Laurent VEYRE, JARDIN (FR); Chloé THIEULEUX, Villeurbanne (FR)

(21) Appl. No.: 18/729,276

(22) PCT Filed: Jan. 13, 2023
(86) PCT No.: PCT/FR2023/000005

§ 371 Date: Jul. 16, 2024

(30) Foreign Application Priority Data
Jan. 18, 2022 (FR) FR2200392

(51) Int. Cl. C07F 7/08; B01J 23/34

(52) U.S. Cl. CPC C07F 7/0829; B01J 23/34

(57) ABSTRACT

The present invention relates to hydrosilylation reactions between a monosubstituted alkene compound and a compound comprising at least one hydrogen atom bonded to a silicon atom. More specifically, the invention relates to a process for the hydrosilylation of an unsaturated compound (A) that comprises at least one monosubstituted alkene function with a compound (B) that comprises at least one hydrosilane function, said process comprising the step of exposing said unsaturated compound (A) and said compound (B) to irradiation in the presence of a photocatalyst (C) consisting of a manganese carbonyl. This hydrosilylation reaction between an alkene compound and a compound comprising at least one hydrogen atom bonded to a silicon atom makes it possible, in particular, to cure silicone compositions by crosslinking.

### TECHNICAL FIELD

The present invention relates to hydrosilylation reactions between a monosubstituted alkene compound and a compound comprising at least one hydrogen atom bonded to a silicon atom. More specifically, the invention relates to a hydrosilylation process photocatalyzed by a manganese complex. This hydrosilylation reaction between an alkene compound and a compound comprising at least one hydrogen atom bonded to a silicon atom makes possible in particular the curing by crosslinking of silicone compositions.

### STATE OF THE PRIOR ART

During a hydrosilylation reaction of alkene compounds (also known as polyaddition), a compound comprising at least one double bond reacts with a compound comprising at least one hydrosilyl function, that is to say a hydrogen atom bonded to a silicon atom. This reaction can, for example, be described by:

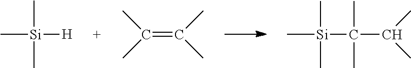

The hydrosilylation reaction can be accompanied, indeed even sometimes replaced, by a dehydrogenative silylation reaction (also known as dehydrosilylation). The reaction can be described by:

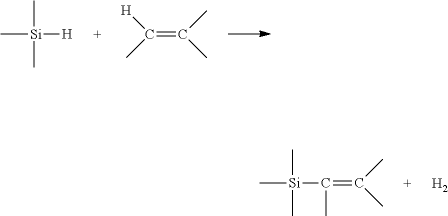

The hydrosilylation reaction is in particular used to crosslink silicone compositions comprising organopolysiloxanes carrying alkenyl units and organopolysiloxanes comprising hydrosilyl functions.

The reaction for the hydrosilylation of alkene compounds is typically carried out by catalysis, using metallic or organometallic catalysts. Currently, the appropriate catalyst for this reaction is a platinum catalyst. Thus, the majority of industrial hydrosilylation processes, in particular for the hydrosilylation of alkenes, are catalyzed by Speier hexachloroplatinic acid or by the Karstedt Pt(0) complex of general formula Pt₂(divinyltetramethyldisiloxane)₃ (or abbreviated to Pt₂(DVTMS)₃).

At the start of the 2000s, the preparation of platinum-carbene complexes made it possible to access more stable catalysts (see, for example, the patent application WO 01/42258).

However, the use of metallic or organometallic platinum catalysts is still problematic. It is an expensive metal which is becoming increasingly scarce and the cost of which fluctuates enormously. It is thus difficult to use on an industrial scale. There is thus a desire to reduce as much as possible the amount of catalyst necessary for the reaction, without, however, reducing the yield and the rate of the reaction. Numerous studies have been carried out to find alternatives to the Karstedt catalyst.

For example, the international patent application WO 2014/096719 A2 describes a process for the hydrosilylation of an unsaturated compound with a hydrosilane compound catalyzed by a photocatalyst chosen from polyoxometallates, for example tetrabutylammonium decatungstate.

In 1966, in the United States patent U.S. Pat. No. 3,271,362, the problem of the replacement of chloroplatinic acid as hydrosilylation catalyst was already touched on. The inventors of this patent proposed the use of a carbonylated metal catalyst chosen from the group consisting of cyclopentadienylcobalt dicarbonyl [C₅H₅Co(CO)₂], dimanganese decacarbonyl [Mn₂(CO)₁₀] and dicobalt octacarbonyl [CO₂(CO)₈]. In the sole embodiment employing dimanganese decacarbonyl, the reaction is carried out at 125° C. and no precise information is given with regard to the yield of the reaction and the nature of the polyaddition products.

In 2021, Dong et al. described, in a scientific publication (“Manganese-catalysed divergent silylation of alkenes”, Nature Chemistry, Volume 13, pages 182-190 (2021)), a manganese-based catalyst for the dehydrosilylation and the hydrosilylation of alkenes. Mn₂(CO)₁₀ is used as metal precursor and has to be combined with a ligand, preferably a JackiePhos ligand, in order to promote the hydrosilylation reaction. The reaction is carried out at 120° C.

Dimanganese decacarbonyl has furthermore been described as catalyst in other reactions. Mention may be made, for example, of the scientific publication of Liang et al. (“Visible-Light-Initiated Manganese-Catalyzed E-Selective Hydrosilylation and Hydrogermylation of Alkyne”, Org. Lett., 2019, 21, 8, 2750-2754), which describes the use of 10 mol % of Mn₂(CO)₁₀ as photocatalyst of the reaction for the hydrosilylation of alkynes. Unlike alkenes, alkynes cannot be subjected to dehydrosilylation.

Regarding dehydrosilylation, a scientific paper by Stefan Weber et al. (“Manganese-Catalyzed Dehydrogenative Silylation of Alkenes Following Two Parallel Inner-Sphere Pathways”, J. Am. Chem. Soc., 2021, 143, 17825-17832) describes the use of an Mn(I) catalyst for the dehydrogenative silylation of terminal alkenes. Two catalysts are proposed: fac-[Mn(dippe)(CO)₃(CH₂CH₂CH₃)] and fac-[Mn(ddre)(CO)₃(CH₂CH₂CH₃)] (dippe=1,2-bis(diisopropylphosphino) and drpe=1,2-bis(di-n-propylphosphino)).

It is in this context that the inventors have sought a more effective process for the hydrosilylation of alkene compounds. Advantageously, it is desired that the reaction be rapid and at moderate temperature, preferably at ambient temperature. Furthermore, it is desired that the hydrosilylation reaction be selective, that the dehydrosilylation and/or isomerization reactions of the alkene compound be reduced, indeed even negligible. Finally, it is desired that the catalyst contain an abundant, inexpensive and nontoxic chemical element.

### SUMMARY OF THE INVENTION

Unexpectedly, the inventors have discovered that the hydrosilylation reaction of monosubstituted alkenes could be photocatalyzed under mild conditions by manganese carbonyl complexes, with excellent yields and an excellent selectivity. In particular, this photocatalyzed reaction produces few or no products of dehydrosilylation and/or of isomerization of the monosubstituted alkene compound.

A subject matter of the present invention is a process for the hydrosilylation of an unsaturated compound (A) comprising at least one monosubstituted alkene function with a compound (B) comprising at least one hydrosilyl function, said process comprising the stage consisting in subjecting said unsaturated compound (A) and said compound (B) to irradiation in the presence of a photocatalyst (C) consisting of a manganese carbonyl.

Another subject matter of the present invention is the use of a manganese carbonyl as photocatalyst of a reaction for the hydrosilylation of an unsaturated compound (A) comprising at least one monosubstituted alkene function with a compound (B) comprising at least one hydrosilyl function.

### DETAILED DESCRIPTION OF THE INVENTION

Unless otherwise indicated, all the viscosities of the silicone oils with which the present document is concerned correspond to a “Newtonian” dynamic viscosity quantity at 25° C., that is to say the dynamic viscosity which is measured, in a manner known per se, with a Brookfield viscometer at a shear rate gradient which is sufficiently low for the viscosity measured to be independent of the rate gradient.

Although not depicted, the possible tautomeric forms of the compounds described in the present account are included within the scope of the present invention.

In the present invention, an alkyl group can be linear or branched. An alkyl group preferably comprises between 1 and 30 carbon atoms, more preferentially between 1 and 12 carbon atoms, more preferentially still between 1 and 6 carbon atoms. An alkyl group can, for example, be chosen from the following groups: methyl, ethyl, n-propyl, isopropyl, n-butyl, isobutyl, s-butyl, t-butyl, n-pentyl, n-hexyl, n-heptyl, n-octyl, n-nonyl, n-decyl, n-undecyl and n-dodecyl.

In the present invention, a cycloalkyl group can be monocyclic or polycyclic, preferably monocyclic or bicyclic. A cycloalkyl group preferably comprises between 3 and 30 carbon atoms, more preferentially between 3 and 8 carbon atoms. A cycloalkyl group can, for example, be chosen from the following groups: cyclopropyl, cyclo-butyl, cyclopentyl, cyclohexyl, cycloheptyl, cyclooctyl, adamantyl and nobornyl.

In the present invention, an aryl group can be monocyclic or polycyclic, preferably monocyclic, and preferably comprises between 6 and 30 carbon atoms, more preferentially between 6 and 18 carbon atoms. An aryl group can be unsubstituted or be substituted one or more times by an alkyl group. The aryl group can be chosen from the phenyl, naphthyl, anthracenyl, phenanthryl, mesityl, tolyl, xylyl, diisopropylphenyl and triisopropylphenyl groups.

In the present invention, an arylalkyl group preferably comprises between 6 and 30 carbon atoms, more preferentially between 7 and 20 carbon atoms. An arylalkyl group can, for example, be chosen from the following groups: benzyl, phenylethyl, phenylpropyl, naphthylmethyl, naphthylethyl and naphthylpropyl.

In the present invention, the halogen atom can, for example, be chosen from the group consisting of fluorine, bromine, chlorine and iodine, fluorine being preferred. An alkyl group substituted by fluorine can, for example, be trifluoropropyl.

According to the definition given by the IUPAC (Glossary of Terms Used in Photochemistry, 3^{rd} Edition; IUPAC Recommendations 2006), a photocatalyst is a catalyst capable of producing, by light absorption, chemical transformations on its reaction partners. The excited state of the photocatalyst interacts with the reaction partners to form reaction intermediates and is itself regenerated after each interaction cycle.

The present invention employs a photocatalyst (C) consisting of a manganese carbonyl. Advantageously, manganese is an abundant natural element generally regarded as non-toxic within the limit of the doses which make a trace element of it. In the present invention, the manganese carbonyl is a metal complex consisting of one or more manganese atoms and of carbonyl ligands bonded to the manganese. No other type of ligand is bonded to the manganese. Preferably, the manganese carbonyl is more specifically dimanganese decacarbonyl, of chemical formula [Mn₂(CO)₁₀]. Advantageously, it is an inexpensive and air-stable commercial product.

The photocatalyst (C) according to the invention is advantageously employed without an organic ligand, in particular:
without a nitrogen-based ligand, such as, for example, a pyridine ligand, and/or
without a phosphorus-based ligand, such as, for example, a phosphine ligand, and/or
without a ligand of acyl type, and/or
without a diketone ligand, such as, for example, a β-diketone ligand, and/or
without a substituted or unsubstituted cyclopentadienyl ligand, and/or
without an organometallic ligand, such as triphenylarsine.

The manganese in the metal complex is preferably in the 0 oxidation state. Said metal complex does not contain a ligand of X type, in particular a halogen ligand.

The molar concentration of photocatalyst (C) can be from 0.01 mol % to 15 mol %, more preferentially from 0.05 mol % to 10 mol %, more preferentially from 0.1 mol % to 5 mol %, more preferentially still from 0.5 mol % to 2 mol %, with respect to the total number of moles of unsaturations carried by the unsaturated compound (A). According to a preferred alternative form, in the process according to the invention, compounds based on platinum, palladium, ruthenium or rhodium are not employed. The amount of compounds based on platinum, palladium, ruthenium or rhodium in the reaction medium is, for example, less than 0.1% by weight, with respect to the weight of the photocatalyst (C), preferably less than 0.01% by weight and more preferentially less than 0.001% by weight.

The present invention consists first of a process for the hydrosilylation of an unsaturated compound (A) comprising at least one monosubstituted alkene function with a compound (B) comprising at least one hydrosilyl function, said process comprising the stage consisting in subjecting said unsaturated compound (A) and said compound (B) to irradiation in the presence of a photocatalyst (C) as described above.

The unsaturated compound (A) employed in the hydrosilylation process according to the invention is a chemical compound comprising at least one monosubstituted alkene unsaturation not forming part of an aromatic ring. It can be chosen from those known to a person skilled in the art and which do not contain a reactive chemical function which can interfere with, indeed even prevent, the hydrosilylation reaction.

In the present text, the term “monosubstituted alkene” or “monosubstituted alkenyl” is understood to mean a covalent double bond between two carbon atoms, not forming part of an aromatic ring, the two carbon atoms being bonded to three hydrogen atoms and a monovalent radical other than a hydrogen atom. The unsaturated compound (A) employed in the hydrosilylation process according to the invention can be represented by the general formula (I):

RCH═CH₂ (I)

in which R represents a monovalent radical.

According to one embodiment, the unsaturated compound (A) comprises one or more monosubstituted alkene functions and from 2 to 40 carbon atoms. The unsaturated compound (A) can be represented by the general formula (I):

RCH═CH₂ (I)

in which R represents a monovalent radical chosen from the group consisting of:
an alkyl group having between 1 and 30 carbon atoms, more preferentially between 1 and 12 carbon atoms, more preferentially still between 1 and 6 carbon atoms, optionally substituted by one or more halogen atoms, such as chlorine or fluorine, and optionally by one or more groups chosen from —OH and —OSiR′₃, in which each R′ represents, independently of one another, H or an alkyl group;
an aryl group having between 6 and 30 carbon atoms, more preferentially between 6 and 18 carbon atoms, optionally substituted by one or more halogen atoms, such as chlorine or fluorine, and optionally by one or more groups chosen from —OH and —OSiR′₃, in which each R′ represents, independently of one another, H or an alkyl group;
an arylalkyl group preferably comprising between 6 and 30 carbon atoms, more preferentially between 7 and 20 carbon atoms, optionally substituted on its aryl part and/or on its alkyl part by one or more halogen atoms, such as chlorine or fluorine, and optionally by one or more groups chosen from —OH and —OSiR′₃, in which each R′ represents, independently of one another, H or an alkyl group;
an ether group of formula —L—O—R″, in which L represents a bond or a divalent radical, preferably an alkylene group having from 1 to 12 carbon atoms, more preferentially still between 1 and 6 carbon atoms, and R″ represents a group chosen from: an alkyl group having between 1 and 30 carbon atoms, more preferentially between 1 and 12 carbon atoms, more preferentially still between 1 and 6 carbon atoms, optionally substituted by one or more halogen atoms, such as chlorine or fluorine, and optionally by one or more groups chosen from —OH and —OSiR′₃, in which each R′ represents, independently of one another, H or an alkyl group; an aryl group having between 6 and 30 carbon atoms, more preferentially between 6 and 18 carbon atoms, optionally substituted by one or more halogen atoms, such as chlorine or fluorine, and optionally by one or more groups chosen from —OH and —OSiR′₃, in which each R′ represents, independently of one another, H or an alkyl group; and an arylalkyl group preferably comprising between 6 and 30 carbon atoms, more preferentially between 7 and 20 carbon atoms, optionally substituted on its aryl part and/or on its alkyl part by one or more halogen atoms, such as chlorine or fluorine, and optionally by one or more groups chosen from —OH and —OSiR′₃, in which each R′ represents, independently of one another, H or an alkyl group;
an ester group of formula —L—O—C(O)—R″, in which L and R″ have the same definitions as given above.

The unsaturated compound (A) can, preferably, be an organic compound comprising a monosubstituted alkene group chosen from the group consisting of:
α-olefins, preferably 1-octene and 1-hexene,
chlorinated α-olefins, preferably allyl chloride,
fluorinated α-olefins, preferably 4,4,5,5,6,6,7,7,7-nonafluoro-1-heptene,
allyl alcohol,
allyl ethers, such as allyl benzyl ether, allyl C₁-C₈ alkyl ethers, allyl glycidyl ether, allyl piperidinyl ether, preferentially sterically hindered allyl piperidinyl ether, or allyl silyl ethers, preferentially allyl trimethylsilyl ether,
allyl esters, such as allyl acetate,
styrenes,
1,2-epoxy-4-vinylcyclohexane,
C₁ to C₄ alkyl acrylates and acrylic acid.

The unsaturated compound (A) can be a disiloxane, such as vinylpentamethyldisiloxane and divinyltetramethyldisiloxane.

The unsaturated compound (A) can be chosen from compounds comprising several monosubstituted alkene functions, preferably two or three monosubstituted alkene functions, and particularly preferably the compound (A) is chosen from the following compounds:

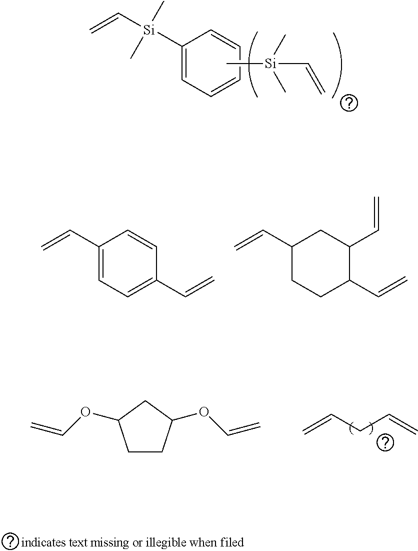

According to a particularly preferred embodiment, the unsaturated compound (A) can be an organopolysiloxane compound comprising one or more monosubstituted alkene functions, preferably at least two monosubstituted alkene functions. The hydrosilylation reaction of alkenes is one of the key reactions in silicone chemistry. It makes possible not only the crosslinking between organopolysiloxanes having SiH functions and organopolysiloxanes having alkenyl functions, in order to form networks and to contribute mechanical properties to materials, but also the functionalization of the organopolysiloxanes having SiH functions, in order to modify their physical and chemical properties.

Said organopolysiloxane compound can in particular be formed:
of at least two siloxyl units of following formula: YₐR¹_{b}SiO_{(4-a-b)/2} in which:
Y is a monosubstituted C₂-C₁₂ alkenyl, preferably vinyl, group,
R¹ is a monovalent hydrocarbon group having from 1 to 12 carbon atoms, preferably chosen from the alkyl groups having from 1 to 8 carbon atoms, such as the methyl, ethyl or propyl groups, the cycloalkyl groups having from 3 to 8 carbon atoms and the aryl groups having from 6 to 12 carbon atoms, and
a=1, 2 or 3, preferably a=1 or 2, more preferentially a=1; b=0, 1 or 2; and the sum a+b=1, 2 or 3; and
optionally of units of following formula: R¹_{c}SiO_{(4-c)/2}
in which R¹ has the same meaning as above and c=0, 1, 2 or 3.

It is understood, in the above formulae, that, if several R¹ groups are present or if several Y groups are present, they can be identical to or different from one another. Preferentially, R¹ can represent a monovalent radical chosen from the group consisting of the alkyl groups having from 1 to 8 carbon atoms, optionally substituted by at least one halogen atom, such as chlorine or fluorine, the cycloalkyl groups having from 3 to 8 carbon atoms and the aryl groups having from 6 to 12 carbon atoms. R¹ can advantageously be chosen from the group consisting of methyl, ethyl, propyl, 3,3,3-trifluoropropyl, xylyl, tolyl and phenyl.

These organopolysiloxane compounds comprising one or more monosubstituted alkene functions can exhibit a linear structure, a cyclic structure or a branched structure.

In the present invention:
a siloxyl unit “M^{Vi}” represents a siloxyl unit of formula YR¹₂SiO_{1/2} or Y₂R¹SiO_{1/2},
a siloxyl unit “M” represents a siloxyl unit of formula R¹₃SiO_{1/2},
a siloxyl unit “D^{Vi}” represents a siloxyl unit of formula YR¹SiO_{2/2},
a siloxyl unit “D” represents a siloxyl unit of formula R¹₂SiO_{2/2},
a siloxyl unit “T” represents a siloxyl unit of formula R¹SiO_{3/2},
a siloxyl unit “Q” represents a siloxyl unit of formula SiO_{4/2},
the symbols Y and R¹ being as described above.

Mention may be made, as examples of terminal “M” and “M^{Vi}” units, of the trimethylsiloxy, dimethylphenylsiloxy, dimethylvinylsiloxy or dimethylhexenylsiloxy groups.

Mention may be made, as examples of “D” and “D^{Vi}” units, of the dimethylsiloxy, methylphenylsiloxy, methylvinylsiloxy, methylbutenylsiloxy, methylhexenylsiloxy, methyldecenylsiloxy or methyldecadienylsiloxy groups.

Linear organopolysiloxane compounds comprising one or more monosubstituted alkene functions essentially consist of “D” and “D^{Vi}” siloxyl units and of “M” and “M^{Vi}” siloxyl units. Examples of linear organopolysiloxanes which can be organopolysiloxane compounds comprising one or more monosubstituted alkene functions according to the invention are:
a poly(dimethylsiloxane) having dimethylvinylsilyl ends;
a poly(dimethylsiloxane-co-methylphenylsiloxane) having dimethylvinylsilyl ends;
a poly(dimethylsiloxane-co-methylvinylsiloxane) having dimethylvinylsilyl ends; and
a poly(dimethylsiloxane-co-methylvinylsiloxane) having trimethylsilyl ends.

In the form most recommended, the organopolysiloxane compound comprising one or more monosubstituted alkene functions contains terminal dimethylvinylsilyl units. More preferentially still, the organopolysiloxane compound comprising one or more monosubstituted alkene functions is a poly(dimethylsiloxane) having dimethylvinylsilyl ends.

A silicone oil generally has a viscosity of between 1 mPa·s and 2 000 000 mPa·s. Preferably, said organopolysiloxane compounds comprising one or more alkene functions are silicone oils with a dynamic viscosity of between 20 mPa·s and 100 000 mPa·s, preferably between 20 mPa·s and 80 000 mPa·s, at 25° C., and more preferentially between 100 mPa·s and 50 000 mPa·s.

Cyclic organopolysiloxane compounds comprising one or more monosubstituted alkene functions essentially consist of “D” and “D^{Vi}” siloxyl units as described above. An example of a cyclic organopolysiloxane which can be an organopolysiloxane compound comprising one or more monosubstituted alkene functions according to the invention is cyclic poly(methylvinylsiloxane).

Optionally, the organopolysiloxane compounds comprising one or more monosubstituted alkene functions can in addition contain “T” siloxyl units and/or “Q” siloxyl units. The organopolysiloxane compounds comprising one or more monosubstituted alkene functions then exhibit a branched structure. Examples of branched organopolysiloxanes, also called resins, which can be organopolysiloxane compounds comprising one or more monosubstituted alkene functions according to the invention, are:
MD^{Vi}Q, where the vinyl groups are included in the D units,
MD^{Vi}TQ, where the vinyl groups are included in the D units,
MM^{Vi}Q, where the vinyl groups are included in a portion of the M units,
MM^{Vi}TQ, where the vinyl groups are included in a portion of the M units,
MM^{Vi}DD^{Vi}Q, where the vinyl groups are included in a portion of the M and D units,
and their mixtures.

Preferably, the organopolysiloxane compound comprising one or more monosubstituted alkene functions has a content by weight of monosubstituted alkenyl unit of between 0.001% and 30%, preferably between 0.01% and 10%, preferably between 0.02% and 5%.

The unsaturated compound (A) reacts according to the present invention with a compound (B) comprising at least one hydrosilyl function.

According to one embodiment, the compound (B) comprising at least one hydrosilyl function is a silane or polysilane compound comprising at least one hydrogen atom bonded to a silicon atom. “Silane” compound is understood to mean, in the present invention, the chemical compounds comprising a silicon atom bonded to four hydrogen atoms or to organic substituents. “Polysilane” compound is understood to mean, in the present invention, the chemical compounds possessing at least one ≡Si—Si≡ unit. Among the silane compounds, the compound (B) comprising at least one hydrosilyl function can be phenylsilane or a mono-, di- or trialkylsilane, for example triethylsilane.

According to another embodiment, the compound (B) comprising at least one hydrosilyl function is an organopolysiloxane compound comprising at least one hydrogen atom bonded to a silicon atom, also referred to as organohydropolysiloxane. Said organohydropolysiloxane can advantageously be an organopolysiloxane formed:
of at least two siloxyl units of following formula: H_{d}R¹ₑSiO_{(4-d-e)/2} in which:
R¹ is a monovalent hydrocarbon group having from 1 to 12 carbon atoms, preferably chosen from the alkyl groups having from 1 to 8 carbon atoms, such as the methyl, ethyl or propyl groups, the cycloalkyl groups having from 3 to 8 carbon atoms and the aryl groups having from 6 to 12 carbon atoms, and
d=1, 2 or 3, preferably d=1 or 2, more preferentially d=1; e=0, 1 or 2; and d+e=1, 2 or 3; and
optionally other units of following formula: R¹_{f}SiO_{(4-f)/2}
in which R¹ has the same meaning as above and f=0, 1, 2 or 3.

It is understood, in the above formulae, that, if several R¹ groups are present, they can be identical to or different from one another. Preferentially, R¹ can represent a monovalent radical chosen from the group consisting of the alkyl groups having from 1 to 8 carbon atoms, optionally substituted by at least one halogen atom, such as chlorine or fluorine, the cycloalkyl groups having from 3 to 8 carbon atoms and the aryl groups having from 6 to 12 carbon atoms. R¹ can advantageously be chosen from the group consisting of methyl, ethyl, propyl, 3,3,3-trifluoropropyl, xylyl, tolyl and phenyl.

The organohydropolysiloxane can exhibit a linear, branched or cyclic structure. The degree of polymerization is preferably greater than or equal to 2. Generally, it is less than 5000.

In that which follows, the “M”, “D”, “T” and “Q” siloxyl units are as defined above, and
the “M” siloxyl units represent a siloxyl unit of formula HR¹₂SiO_{1/2},
the “D′” siloxyl units represent a siloxyl unit of formula HR¹SiO_{2/2},
the symbol R¹ being as described above.

When linear polymers are concerned, these essentially consist of siloxyl units chosen from the “D” and “D” siloxyl units and of “M” and “M” terminal siloxyl units. Examples of organohydropolysiloxanes which can be compounds (B) comprising at least one hydrosilyl function according to the invention are:
a poly(dimethylsiloxane) having hydrodimethylsilyl ends;
a poly(dimethylsiloxane-co-methylhydrosiloxane) having trimethylsilyl ends;
a poly(dimethylsiloxane-co-methylhydrosiloxane) having hydrodimethylsilyl ends; and
a poly(methylhydrosiloxane) having trimethylsilyl ends.

When the organohydropolysiloxane exhibits a cyclic structure, it essentially consists of siloxyl units chosen from the “D” and “D” siloxyl units. An example of a cyclic organohydropolysiloxane which can be a compound (B) comprising at least one hydrosilyl function according to the invention is a cyclic poly(methylhydrosiloxane).

When the organohydropolysiloxane exhibits a branched structure, it is preferably chosen from the group consisting of the silicone resins of following formulae:
M′Q, where the hydrogen atoms bonded to silicon atoms are carried by the M groups,
MM′Q, where the hydrogen atoms bonded to silicon atoms are carried by a portion of the M units,
MD′Q, where the hydrogen atoms bonded to silicon atoms are carried by the D groups,
MDD′Q, where the hydrogen atoms bonded to silicon atoms are carried by a portion of the D groups,
MM′TQ, where the hydrogen atoms bonded to silicon atoms are carried by a portion of the M units,
MM′DD′Q, where the hydrogen atoms bonded to silicon atoms are carried by a portion of the M and D units,
and their mixtures.

Preferably, the organohydropolysiloxane compound has a content by weight of hydrosilyl Si—H functions of between 0.2% and 91%, more preferentially between 3% and 80% and more preferentially still between 15% and 70%.

According to a particular embodiment of the present invention, it is possible for the unsaturated compound (A) and the compound (B) comprising at least one hydrosilyl function to be one and the same compound comprising, on the one hand, at least one monosubstituted alkene function and, on the other hand, at least one silicon atom and at least one hydrogen atom bonded to the silicon atom. This compound can then be described as “bifunctional” and it is capable of reacting with itself by a hydrosilylation reaction. The invention can thus also relate to a process for the hydrosilylation of a bifunctional compound with itself, said bifunctional compound comprising, on the one hand, at least one monofunctional alkene function and, on the other hand, at least one silicon atom and at least one hydrogen atom bonded to the silicon atom, said process being photocatalyzed by the photocatalyst (C) as described above.

Examples of organopolysiloxanes which can be bifunctional compounds are:
a poly(dimethylsiloxane-co-hydromethylsiloxane-co-vinylmethylsiloxane) having dimethylvinylsilyl ends;
a poly(dimethylsiloxane-co-hydromethylsiloxane-co-vinylmethylsiloxane) having dimethylhydrosilyl ends; and
a poly(dimethylsiloxane-co-hydromethylsiloxane-co-(propyl glycidyl ether)methylsiloxane) having trimethylsilyl ends.

When the use of the unsaturated compound (A) and of the compound (B) comprising at least one hydrosilyl function is concerned, a person skilled in the art understands that this also means the use of a bifunctional compound.

The amounts of compound (A) and of compound (B) can be controlled so that the molar ratio of the hydrosilyl functions of the compounds (B) to the monosubstituted alkene functions of the compounds (A) is preferably between 1:10 and 10:1, more preferably between 1:5 and 5:1, more preferably between 1:3 and 3:1, and more preferably still between 1:2 and 2:1.

The process according to the present invention comprising the stage consisting in subjecting said unsaturated compound (A) and said compound (B) to irradiation in the presence of the photocatalyst (C).

The irradiation is preferably an exposure to UV and/or visible radiation. In the present text, “UV” means ultraviolet. Ultraviolet radiation is defined as electromagnetic radiation, the wavelength of which is between approximately 100 nm and approximately 400 nm, i.e. below the spectrum of visible light. Within UV radiation, it is possible to define UV-A radiation, the wavelength of which is between approximately 315 nm and approximately 400 nm, UV-B radiation, the wavelength of which is between approximately 280 nm and approximately 315 nm, and UV-C radiation, the wavelength of which is between approximately 100 nm and approximately 280 nm. Visible radiation is defined as electromagnetic radiation, the wavelength of which is between approximately 400 nm and approximately 800 nm. Preferably, irradiation is carried out by exposure to radiation with a wavelength of between 100 nm and 450 nm, or between 200 nm and 420 nm, or between 250 nm and 405 nm.

The radiation can be emitted by doped or undoped mercury vapor lamps, the emission spectrum of which extends from 100 nm to 450 nm. Light sources, such as LEDs, which deliver point UV or visible light, can also be employed. Furthermore, in the present text, “LED” is the abbreviation, well known to a person skilled in the art, for “light-emitting diode”.

According to one embodiment, irradiation is carried out with UV radiation, the source of which is a UV-LED lamp. Said UV-LED lamp can emit radiation with a wavelength of 365 nm, 385 nm, 395 nm or 405 nm. Preferably, the UV-LED lamp is a lamp emitting at 395 nm. The power of the UV-LED lamp is preferably between 2 W/m² and 200 000 W/m².

According to a preferred embodiment, the irradiation stage is carried out under an inert atmosphere, for example under nitrogen, under argon or under oxygen-depleted air.

The irradiation stage is carried out at a temperature of between 0° C. and 60° C., more preferably between 15° C. and 60° C., more preferably between 20° C. and 40° C. and more preferably still at ambient temperature, i.e. typically approximately 25° C.

The hydrosilylation reaction can be carried out in a solvent or in the absence of solvent. Appropriate solvents are solvents miscible with the compound (B). For example, the solvent can be chosen from the group consisting of aliphatic hydrocarbons, such as pentane, hexane, heptane, cyclohexane, decalin and liquid paraffins; aromatic hydrocarbons, such as toluene and xylene; mixtures of hydrocarbons of mineral or synthetic origin, such as white spirit; ethers, such as tetrahydrofuran, dioxane, diethyl ether and diphenyl ether; chlorinated hydrocarbons, such as methylene chloride, 1,2-dichloroethane, perchloroethylene and chlorobenzene; esters, such as ethyl acetate, butyl acetate and butyrolactone; acetonitrile; dimethylformamide; dimethyl sulfoxide; N-methylpyrrolidone; polyethylene glycols; and their mixtures. Preferably, the solvent can be chosen from the group consisting of aliphatic hydrocarbons, aromatic hydrocarbons and chlorinated hydrocarbons, and more preferentially from the group consisting of hexane, cyclohexane, decalin and toluene. In an alternative form, the solvent can be chosen from volatile silicones, octamethylcyclotetrasiloxane (D4), decamethylcyclopentasiloxane (D5), polydimethylsiloxane oils (PDMSs), polyphenylmethylsiloxane oils (PPMSs) or their mixtures. In an alternative form, one of the reactants, for example the unsaturated compound (A), can act as solvent. Preferably, the use of organic solvents harmful to the environment and to the health of workers in manufacturing plants will be avoided.

According to a preferred embodiment of the invention, the compounds (A) and (B) employed are chosen from the organopolysiloxanes as defined above. In this case, a three-dimensional network is formed, which results in the curing of the composition. The crosslinking involves a gradual physical change in the medium constituting the composition. Consequently, the process according to the invention can be used to obtain elastomers, gels, foams, and the like. In this case, a crosslinked silicone material is obtained. The term “crosslinked silicone material” is understood to mean any silicone-based product obtained by crosslinking and/or curing of compositions comprising organopolysiloxanes possessing at least two unsaturated bonds and organopolysiloxanes possessing at least three hydrosilyl units. The crosslinked silicone material can, for example, be an elastomer, a gel or a foam.

Still according to this preferred embodiment of the process according to the invention, where the compounds (A) and (B) are chosen from the organopolysiloxanes as defined above, it is possible to employ usual functional additives in the silicone compositions. Mention may be made, as families of usual functional additives, of:
fillers,
adhesion promoters,
inhibitors or retarders of the hydrosilylation reaction,
adhesion modulators,
silicone resins,
consistency-enhancing additives,
pigments (organic or inorganic), and
heat resistance, oil resistance or fire resistance additives, for example metal oxides.

The filler optionally provided is preferably inorganic. The filler can be a very finely divided product, the mean particle diameter of which is less than 0.1 μm. The filler can in particular be siliceous. As regards the siliceous substances, they can act as reinforcing or semi-reinforcing filler. The reinforcing siliceous fillers are chosen from colloidal silicas, fumed and precipitated silica powders or their mixtures. These powders exhibit a mean particle size generally of less than 0.1 μm (micrometers) and a BET specific surface of greater than 30 m²/g, preferably of between 30 and 350 m²/g. Semi-reinforcing siliceous fillers, such as diatomaceous earths or ground quartz, can also be employed. These silicas can be incorporated as is or after having been treated with organosilicon compounds generally employed for this use. These compounds include methylpolysiloxanes, such as hexamethyldisiloxane or octamethylcyclotetrasiloxane, methylpolysilazanes, such as hexamethyldisilazane, hexamethylcyclotrisilazane or tetramethyldivinyldisilazane, chlorosilanes, such as dimethyldichlorosilane, trimethylchlorosilane, methylvinyldichlorosilane or dimethylvinylchlorosilane, alkoxysilanes, such as dimethyldimethoxysilane, dimethylvinylethoxysilane or trimethylmethoxysilane, and their mixtures. As regards the non-siliceous inorganic substances, they can be involved as semi-reinforcing or bulking inorganic filler. Examples of these non-siliceous fillers which can be used, alone or as a mixture, are calcium carbonate, optionally surface-treated with an organic acid or with an ester of an organic acid, calcined clay, titanium oxide of the rutile type, iron, zinc, chromium, zirconium or magnesium oxides, the various forms of alumina (hydrated or non-hydrated), boron nitride, lithopone, barium metaborate, barium sulfate and glass microbeads. These fillers are coarser with generally a mean particle diameter of greater than 0.1 μm and a specific surface generally of less than 30 m²/g. These fillers may have been surface-modified by treatment with the various organosilicon compounds generally employed for this use. Preferably, the filler is silica and more preferentially still fumed silica. Advantageously, the silica has a BET specific surface of between 75 and 410 m²/g. A silicone composition can comprise between 5% and 20% by weight of filler, with respect to the total weight of the silicone composition. Advantageously, the silicone composition can comprise between 8% and 15% by weight of filler.

The discovery of this novel hydrosilylation process photocatalyzed under mild conditions according to the present invention makes it possible to envisage numerous applications.

According to a first embodiment, the hydrosilylation process according to the present invention can be used for the functionalization of organopolysiloxanes having SiH functions. The objective of the functionalization is to modify the physical and/or chemical properties of said organopolysiloxanes and to produce novel compounds having improved properties. According to this embodiment, the unsaturated compound (A) comprising at least one monosubstituted alkene function is chosen from the unsaturated compounds comprising one or more monosubstituted alkene functions and from 2 to 40 carbon atoms and the compound (B) comprising at least one hydrosilyl function is an organopolysiloxane compound comprising at least one hydrogen atom bonded to a silicon atom. A process for the functionalization of organopolysiloxanes having SiH functions may be described, characterized in that the addition reaction between organopolysiloxanes having SiH functions and unsaturated compounds (A) comprising one or more monosubstituted alkene functions and from 2 to 40 carbon atoms is obtained by the hydrosilylation process as described above.

According to another particularly preferred embodiment, the hydrosilylation process according to the present invention can be used for the crosslinking between organopolysiloxanes having SiH functions and organopolysiloxanes having alkenyl functions in order to form networks and to contribute mechanical properties to the materials. According to this embodiment, the unsaturated compound (A) comprising at least one monosubstituted alkene function is an organopolysiloxane compound comprising at least two monosubstituted alkene functions and the compound (B) comprising at least one hydrosilyl function is an organopolysiloxane compound comprising at least three hydrogen atoms bonded to a silicon atom. A process for the preparation of cross-linked silicone materials may be described, characterized in that the crosslinking reaction between organopolysiloxanes having SiH functions and organopolysiloxanes having alkenyl functions is obtained by the hydrosilylation process as described above. The crosslinked silicone materials thus obtained can be used in different applications, in particular:
applications of coating type, where a support is covered with a silicone coating;
applications in the electronics field, for example for the preparation of conformal coatings of printed circuits, and for the potting of microcircuits and of electronic components, such as IGBTs;
additive manufacturing processes (also known as 3D printing processes) employing photopolymerization.

Other details or advantages of the invention will become more clearly apparent in the light of the examples given below purely by way of indication.

### EXAMPLES

### Examples 1-3 and Comparative Examples 1-3: Hydrosilylation of 1-Octene (1) with 1,1,1,3,5,5,5-Heptamethyltrisiloxane (2)

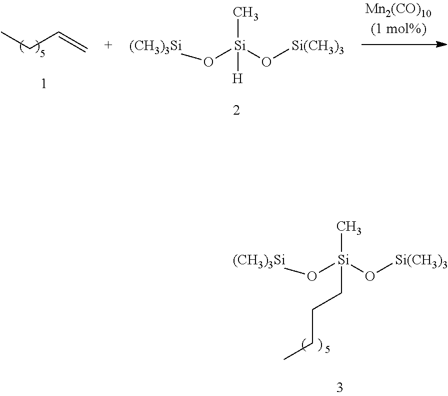

1-Octene (1) and 1,1,1,3,5,5,5-heptamethyltrisiloxane (2) were introduced into a 4 ml vial under an argon atmosphere at ambient temperature. A solution of dimanganese decacarbonyl Mn₂(CO)₁₀ in toluene was injected into the vial and toluene was added. Final concentration of Mn₂(CO)₁₀ (with respect to the 1-octene)=1 mol %.

In examples 1, 2 and 3, the reaction mixture was placed under UV light for 4 hours (300 W, λ=250-420 nm). In comparative examples 1, 2 and 3, the reaction mixture was not irradiated but was heated for 24 hours. The concentrations of the reactants and the conditions of the reaction are as shown in table 1, and also the yields of hydrosilylation product (3) and of product of the isomerization of (1) (determined by gas chromatography, calculated with respect to the 1-octene).

TABLE 1

| | | Conc. | Conc. | Yield | Isomerization |
|---|---|---|---|---|---|
| | Conditions | (1) | (2) | of (3) | of (1) |
| Ex. I | UV, 4 h | 0.825M | 1.650M | 94% | no product |
| Ex. 2 | UV, 4 h | 1.650M | 1.650M | 78% | 1% |
| Ex. 3 | UV, 4 h | 3.3M | 1.650M | 86% | 3% |
| Comp. I | 30° C., 24 h | 0.825M | 1.650M | no product | no product |
| Comp. 2 | 60° C., 24 h | 0.852M | 1.650M | no product | no product |
| Comp. 3 | 100° C., 24 h | 0.825M | 1.650M | no product | no product |

Examples 1, 2 and 3 show that the hydrosilylation reaction between 1-octene (1) and 1,1,1,3,5,5,5-heptamethyltrisiloxane (2) photocatalyzed by Mn₂(CO)₁₀ makes it possible to obtain a product (3) with an excellent yield and an excellent selectivity, under mild reaction conditions (4 hours at ambient temperature). Conversely, the catalyst does not show activity by thermal activation (comparative examples 1, 2 and 3).

### Examples 4-12 and Comparative Examples 4-6: Hydrosilylation of Different Alkenes (1′)

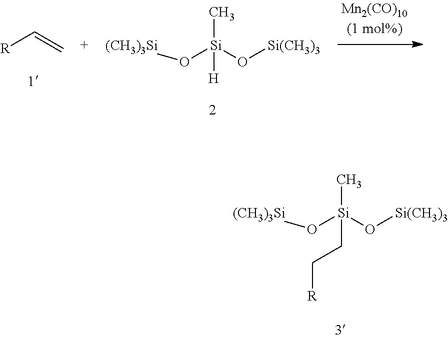

The same procedure described in example 1 (UV, 4 h) was followed while varying the structure of the alkene compound (1′) as indicated in table 2 below. The yield of hydrosilylation product (3′) (determined by gas chromatography, calculated with respect to the alkene) is shown in table 2.

TABLE 2

| | Alkene (1′) | Yield of (3′) |
|---|---|---|
| Ex.4 | 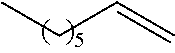 | 94% |
| Ex.5 | 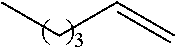 | >99% |
| Ex.6 | 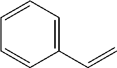 | >99% |
| Ex.7 | 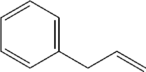 | >99% |
| Ex.8 | 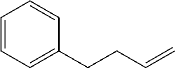 | 80% |
| Ex.9 | 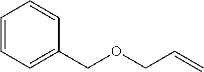 | >99% |
| Ex. 10 | 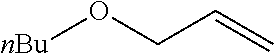 | 70% |
| Ex.11 | 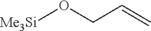 | 77% |
| Ex. 12 | 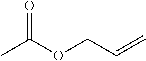 | 47% |
| Comp.4 | 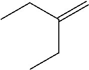 | no product |
| Comp.5 | 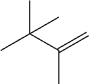 | no product |
| Comp.6 | 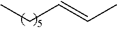 | no product |

In examples 4 to 12, the hydrosilylation products were obtained with an excellent selectivity. No C═C isomerization nor any product from the splitting of the C—O bond was observed. On the other hand, the hydrosilylation product is not obtained starting from gem-disubstituted alkenes (comparative examples 4 and 5) or starting from an internal alkene (comparative example 6).

1. A process for hydrosilylation of an unsaturated compound (A) comprising at least one monosubstituted alkene function with a compound (B) comprising at least one hydrosilyl function, said process comprising subjecting said unsaturated compound (A) and said compound (B) to irradiation in the presence of a photocatalyst (C) comprising manganese carbonyl.

2. The process of claim 1, wherein the manganese in the manganese carbonyl is in 0 oxidation state.

3. The process of claim 1, wherein the manganese carbonyl is dimanganese decacarbonyl, of chemical formula [Mn₂(CO)₁₀].

4. The process of claim 1, wherein the unsaturated compound (A) is an organic compound comprising a monosubstituted alkene group selected from the group consisting of:
α-olefins, optionally 1-octene and 1-hexene,
chlorinated α-olefins, optionally allyl chloride,
fluorinated α-olefins, optionally 4,4,5,5,6,6,7,7,7-nonafluoro-1-heptene,
allyl alcohol,
allyl ethers, optionally allyl benzyl ether, allyl C1-C8 alkyl ethers, allyl glycidyl ether, allyl piperidinyl ether, optionally sterically hindered allyl piperidinyl ether, or allyl silyl ethers, optionally allyl trimethylsilyl ether,
allyl esters, optionally allyl acetate,
styrenes,
1,2-epoxy-4-vinylcyclohexane,
C₁ to C₄ alkyl acrylates and acrylic acid.

5. The process of claim 1, wherein the unsaturated compound (A) is an organopolysiloxane compound comprising one or more monosubstituted alkene functions, optionally at least two monosubstituted alkene functions.

6. The process of claim 1, wherein the compound (B) comprising at least one hydrosilyl function is an organopolysiloxane compound comprising at least one hydrogen atom bonded to a silicon atom.

7. The process of claim 1, wherein irradiation is carried out by exposure to radiation with a wavelength of between 100 nm and 450 nm, optionally between 200 nm and 420 nm, optionally between 250 nm and 405 nm.

8. The process of claim 1, wherein irradiation is carried out with UV radiation, the source of which is a UV-LED lamp.

9. The process of claim 1, wherein irradiation is carried out at a temperature of between 0° C. and 60° C., optionally between 15° C. and 60° C., optionally between 20° C. and 40° C., optionally at ambient temperature.

10. The process of claim 1, for functionalization of organopolysiloxane having SiH functions, wherein the unsaturated compound (A) comprising at least one monosubstituted alkene function is chosen from unsaturated compounds comprising one or more monosubstituted alkene functions and from 2 to 40 carbon atoms and the compound (B) comprising at least one hydrosilyl function is an organopolysiloxane compound comprising at least one hydrogen atom bonded to a silicon atom.

11. The process of claim 1, for preparation of a crosslinked silicone material, wherein the unsaturated compound (A) comprising at least one monosubstituted alkene function is an organopolysiloxane compound comprising at least two monosubstituted alkene functions and the compound (B) comprising at least one hydrosilyl function is an organopolysiloxane compound comprising at least three hydrogen atoms bonded to a silicon atom.

12. A product comprising manganese carbonyl as a photocatalyst of a reaction for the hydrosilylation of an unsaturated compound (A) comprising at least one monosubstituted alkene function with a compound (B) comprising at least one hydrosilyl function.

13. The product of claim 12, wherein the manganese in the manganese carbonyl is in 0 oxidation state.

14. The product of claim 12, wherein the manganese carbonyl is dimanganese decacarbonyl, of chemical formula [Mn₂(CO)₁₀].
